(19) United States
(12) Patent Application Publication
(10) Pub. No.: US 2009/0025035 A1
(43) Pub. Date: Jan. 22, 2009

(54) Control apparatus, control method and program

(75) Inventors: Mikiko Sakurai, Tokyo (JP); Takefumi Kitayama, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/218,288

(22) Filed: Jul. 14, 2008

(30) Foreign Application Priority Data
Jul. 18, 2007 (JP) P2007-186562

(51) Int. Cl. H04N 5/445; H04N 5/91; G06F 13/00

(52) U.S. Cl. 725/44; 386/83; 725/58; 386/E09.001

(57) ABSTRACT

A control apparatus that controls the programmed recording of a program includes an EPG data obtaining section obtaining EPG data, an EPG display control section causing a display device to display an EPG, and a programming section programming a program by creating programming data including a recording ending time based on a user's operation on the EPG, wherein the programming section defines a distribution ending time when the distribution of a target program, which is a program to be programmed, is to be ended as the recording ending time if the distribution ending time is available, or defines, as the recording ending time, the time after a predetermined estimated time stored in a storage section, which stores information, from a distribution starting time when the distribution of the target program is to be started if the distribution ending time of the target program is not available.

### CROSS REFERENCES TO RELATED APPLICATIONS

The present invention contains subject matter related to Japanese Patent Application JP 2007-186562 filed in the Japanese Patent Office on Jul. 18, 2007, the entire contents of which being incorporated herein by reference.

### BACKGROUND OF THE INVENTION

1. Field of the Invention

The present invention relates to a control apparatus, control method and program, and it particularly relates to a control apparatus, control method and program that allow easy programming.

2. Description of the Related Art

In digital broadcasting such as terrestrial digital broadcasting and BS (Broadcasting Satellite) digital broadcasting, information called PSI (Program Specific Information)/SI (Service Information) is also broadcasted in addition to video data and audio data as a program.

The PSI/SI includes information such as program information, program configuration information and program schedule information.

Here, the program information is information regarding a program, such as the title of the program, the broadcasting starting time when the broadcasting (distribution) of the program is to be started, the broadcasting ending time when the broadcasting of the program is to be ended, performers and the channel at which the program is broadcasted. The program configuration information is information for identifying components of a program, that is, a TS (Transport Stream) packet contained in video data and audio data as a program, for example. The program schedule information is information such as the broadcasting ending time of the program being currently broadcasted and the broadcasting starting time of the next program (the program to be broadcasted after the current program). This information may allow the recognition of the fact that the broadcasting time of the current program has been extended and/or the broadcasting starting time of the next program, which is carried down by the extension, for example.

For example, a digital TV (television receiver) that receives digital broadcasting obtains (extracts) EPG data for displaying an EPG (Electronic Program Guide) from the PSI/SI and displays the EPG based on the EPG data.

In a case where a digital TV connects to a recorder (such as an HD (Hard Disk) recorder) the programming of which is controllable by the digital TV, the digital TV programs based on a user's operation on the EPG.

In other words, when a user selects, as a target program to be programmed (which will be called target program as appropriate), one of the programs the program columns of which are listed on the EPG, the target program is programmed in the digital TV.

Thus, a user can use the EPG to easily program.

The digital TV programmed as described above requests the recorder the programming according to the programming data by transmitting programming data containing the channel subject to the programming (the channel at which the target program is to be broadcasted), the recording starting time when the programmed recording is to be started and the recording ending time when the recording is to be ended to the recorder. Thus, the recorder is caused to implement the programmed recording of the target program.

Alternatively, the digital TV transmits a recording start command that requests starting the recording of the program at the channel subject to the programmed recording to the recorder when it is the recording starting time. Then, the digital TV transmits the recording end command that requests ending the recording to the recorder when it is the recording ending time. Thus, the recorder is caused to (be program to) record the target program.

The technology has been proposed (refer to WO2004/091200 (Patent Document 1), for example) that address the situation that it is difficult to record the program desired by a user since recording is performed based on the programming data upon programming in a case where the program schedule is changed after the programming.

### SUMMARY OF THE INVENTION

In programming in a digital TV in the past, the broadcasting starting time and broadcasting ending time of a target program are obtained from EPG data (or PSI/SI), and the broadcasting starting time and broadcasting ending time are defined as the recording starting time and recording ending time, respectively.

It may be difficult to obtain the broadcasting ending times from the EPG data (or PSI/SI) of some programs. In other words, the broadcasting ending time of a program to be broadcasted until the game ends, like the high school baseball game broadcast live, for example, may be replaced by the information indicating that it is undetermined on the EPG data, or the EPG data may not have the broadcasting ending time of the program. In this case, it is difficult to obtain the broadcasting ending time.

In a digital TV in the past, in a case where it is difficult to obtain the broadcasting ending time of a program, the attempt to program by using the EPG results in an error. Therefore, in order to program a program the broadcasting ending time of which is not available, it is important for a user to perform the date/time-specified programming that programs a program by specifying all of the channel of the program, the recording starting time and the recording ending time, which takes a longer time than that of the programming by using an EPG, that is, the programming only by selecting a target program (or program column) on an EPG.

Accordingly, it is desirable to allow easy programming even a program the broadcasting ending time of which is not available.

According to an embodiment of the present invention, there is provided a control apparatus that controls the programmed recording of a program or a program causing a computer to function as a control apparatus that controls the programmed recording of a program, the apparatus including an EPG data obtaining section obtaining EPG (Electronic Program Guide) data for displaying an EPG, an EPG display control section causing a display device, which displays an image, to display an EPG based on the EPG data, and a programming section programming a program by creating programming data including a recording ending time when the recording of a program is to be ended based on a user's operation on the EPG, wherein the programming section defines a distribution ending time when the distribution of a target program, which is a program to be programmed, is to be ended as the recording ending time if the distribution ending time is available or defines, as the recording ending time, the time after a predetermined estimated time stored in a storage section, which stores information, from a distribution starting time when the distribution of the target program is to be started if the distribution ending time of the target program is not available.

According to another embodiment of the invention, there is provided a control method that controls the programmed recording of a program, the method including the steps of: obtaining EPG (Electronic Program Guide) data for displaying an EPG, controlling a display device, which displays an image, to display an EPG based on the EPG data, and programming a program by creating programming data including a recording ending time when the recording of a program is to be ended based on a user's operation on the EPG, wherein the programming step defines a distribution ending time when the distribution of a target program, which is a program to be programmed, is to be ended as the recording ending time if the distribution ending time is available, or defines, as the recording ending time, the time after a predetermined estimated time stored in a storage section, which stores information, from a distribution starting time when the distribution of the target program is to be started if the distribution ending time of the target program is not available.

According to an embodiment of the invention as described above, EPG (Electronic Program Guide) data for displaying an EPG is obtained, and, based on the EPG data, the EPG is displayed on a display device, which displays an image. A program is programmed by creating programming data including a recording ending time when the recording of a program is to be ended based on a user's operation on the EPG. In the programming, a distribution ending time when the distribution of a target program, which is a program to be programmed, is to be ended is defined as the recording ending time if the distribution ending time is available, or, as the recording ending time, the time after a predetermined estimated time stored in a storage section, which stores information, from a distribution starting time when the distribution of the target program is to be started is defined if the distribution ending time of the target program is not available.

The program may be transmitted through a transmission medium or may be recorded on and provided through a recording medium.

The control apparatus may be a standalone apparatus or may be an internal block included in one system.

According to an embodiment of the invention, the programming can be performed easily.

### BRIEF DESCRIPTION OF THE DRAWINGS

FIG. 1 is a block diagram showing a configuration example of an embodiment of a recording system to which the invention is applied;

FIG. 2 is a block diagram showing a configuration example of a TV 2;

FIG. 3 is a block diagram showing a configuration example of an embodiment of a recording control apparatus; and

FIG. 4 is a flowchart illustrating EPG display processing.

### DESCRIPTION OF THE PREFERRED EMBODIMENTS

Embodiments of the invention will be described below where the correspondence between constituent features of the invention and embodiments described in the specification or drawings will be illustrated as follows. This description is for confirming that embodiments supporting the invention are described in the specification or drawings. Therefore, the existence of an embodiment described in the specification or drawings but not described herein as an embodiment corresponding to a constituent feature of the invention does not mean that the embodiment does not correspond to the constituent feature. Conversely, the existence of an embodiment described herein as one corresponding to a constituent feature does not means that the embodiment does not correspond to other constituent features excluding the constituent feature.

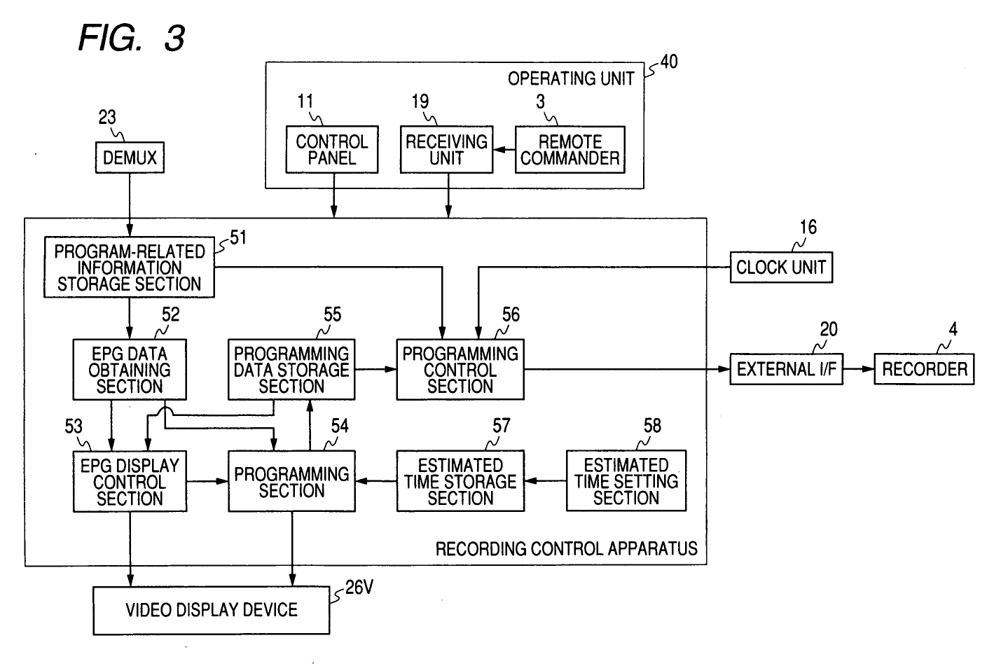

According to an embodiment of the invention, there is provided a control apparatus (such as a recording control apparatus in FIG. 3) that controls the programmed recording of a program or a program causing a computer to function as a control apparatus that controls the programmed recording of a program, the apparatus including an EPG data obtaining section (such as an EPG data obtaining section 52 in FIG. 3) obtaining EPG data for displaying an EPG (Electronic Program Guide), an EPG display control section (such as an EPG display control section 53 in FIG. 3) causing a display device (such as a video display device 26V in FIG. 3), which displays an image, to display an EPG based on the EPG data, and a programming section (such as a programming section 54 in FIG. 3) programming a program by creating programming data including a recording ending time when the recording of a program is to be ended based on a user's operation on the EPG, wherein the programming section defines a distribution ending time when the distribution of a target program, which is a program to be programmed, is to be ended as the recording ending time if the distribution ending time is available or defines, as the recording ending time, the time after a predetermined estimated time stored in a storage section (such as an estimated time storage section 57 in FIG. 3), which stores information, from a distribution starting time when the distribution of the target program is to be started if the distribution ending time of the target program is not available.

The control apparatus according to the embodiment may further include an estimated time setting section (such as an estimated time setting section 58 in FIG. 3) setting the estimated time to be stored in the storage section.

The control apparatus according to the embodiment may further include a programmed recording control section (such as a programmed recording control section 56 in FIG. 3) controlling the programmed recording of a program based on the programming data, wherein the programmed recording control section ends the programmed recording of the target program if the distribution of the next program of the target program is started after the programmed recording of the program is started and before the recording ending time of the target program is started.

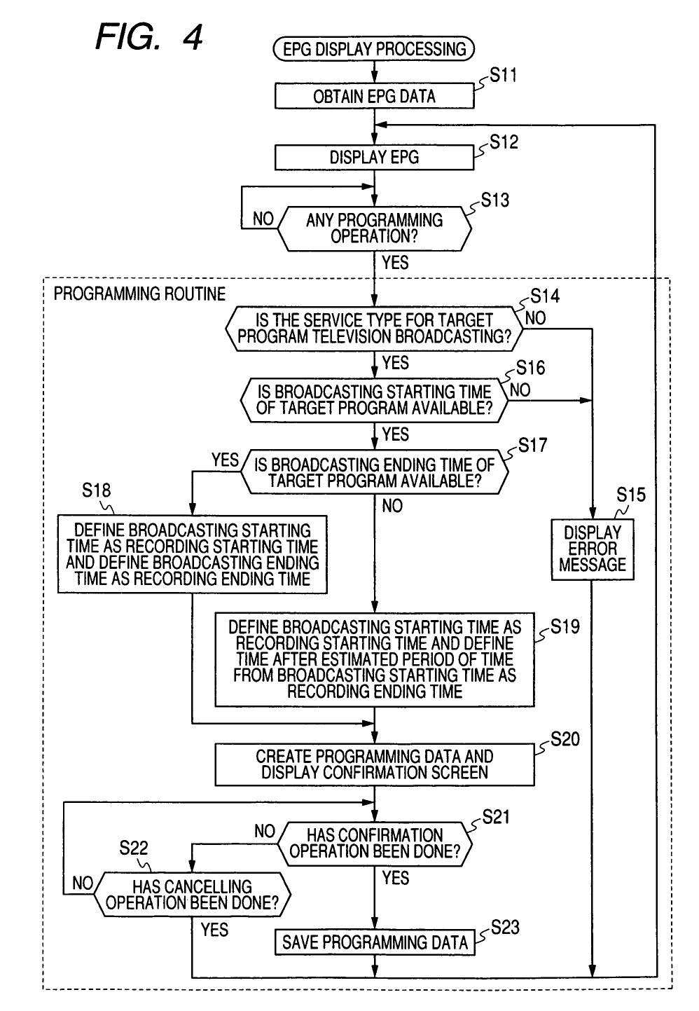

According to another embodiment of the invention, there is provided a control method that controls the programmed recording of a program, the method including an EPG data obtaining step (such as step S11 in FIG. 4) of obtaining EPG data for displaying an EPG (Electronic Program Guide), an EPG display control step (such as step S12 in FIG. 4) of causing a display device, which displays an image, to display an EPG based on the EPG data, and a programming step (such as steps S14 to S23 in FIG. 4) of programming a program by creating programming data including a recording ending time when the recording of a program is to be ended based on a user's operation on the EPG, wherein the programming step defines a distribution ending time when the distribution of a target program, which is a program to be programmed, is to be ended as the recording ending time if the distribution ending time is available (such as step S18 in FIG. 4), or defines, as the recording ending time, the time after a predetermined estimated time stored in a storage section, which stores information, from a distribution starting time when the distribution of the target program is to be started if the distribution ending time of the target program is not available (such as step S19 in FIG. 4).

With reference to drawings, embodiments of the invention will be described below.

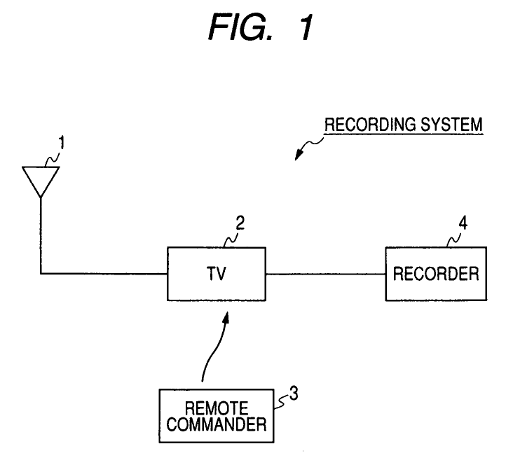

FIG. 1 is a block diagram showing a configuration example of an embodiment of a recording system to which the invention is applied (where the term “system” refers to a logical set of multiple apparatus, and the component apparatus may be or may not be within one same cabinet).

In FIG. 1, the recording system includes an antenna 1, a TV 2, a remote commander 3 and a recorder 4.

The antenna 1 may receive broadcast waves of digital broadcasting and supply the resulting receive signal to the TV 2, for example.

The TV 2 extracts video data and audio data as a program and/or EPG data from the receive signal from the antenna 1, displays the images corresponding to the video data and/or the EPG corresponding to the EPG data and outputs the sounds corresponding to the audio data.

The TV 2 programs a program based on an operation signal from the remote commander 3, for example, and controls the programmed recording of the program by the recorder 4 based on the programming.

The remote commander 3 is operated by a user and transmits the operation signal corresponding to the operation by radio such as infrared rays to the TV 2.

The recorder 4 is a recording apparatus such as an HD recorder and records (or is programmed to record) a program under the control of the TV 2.

In the TV 2 with the recording system in the configuration as described above, video data and audio data as a program and/or EPG data are extracted from the receive signal from the antenna 1, and the images corresponding to the video data as the program are displayed, and the sounds corresponding to the audio data as the program are output.

For example, if a user operates the remote commander 3 to display an EPG, the TV 2 displays the EPG based on the EPG data extracted from the receive signal.

If a user selects one of programs with the program columns on the EPG displayed on the TV 2 as a program subject to programming (which will be called target program), the TV 2 programs the target program.

In other words, the TV 2 requests the recorder 4 the programming according to programming data by creating the programming data including the channel subject to the programming (or the channel at which the target program is to be broadcasted), the recording starting time when the programmed recording is to be started and the recording ending time when the programmed recording is to be ended, for example, and transmitting it to the recorder 4. Thus, the TV 2 causes the recorder 4 to perform the programming of the target program.

Alternatively, at the recording starting time, the TV 2 transmits the recorder 4 a recording start command that requests the start of recording of the programmed channel. Then, at the recording ending time, the TV 2 transmits the recorder 4 a recording end command that requests the end of recording. Thus, the recorder 4 is caused to record (or to be programmed to record) the target program.

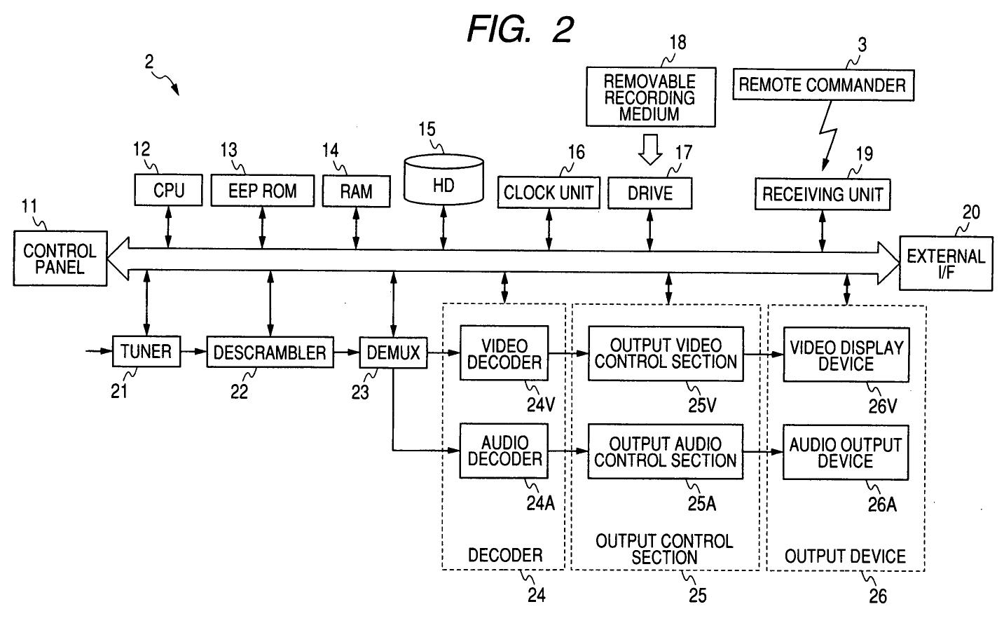

FIG. 2 is a block diagram showing a configuration example of the TV 2 in FIG. 1.

In FIG. 2, the TV 2 includes a control panel 11, a CPU 12, an EEPROM (Electrically Erasable Programmable Read Only Memory) 13, a RAM (Random Access Memory) 14, an HD (Hard Disk) (HD drive) 15, a clock unit 16, a drive 17, a receiving unit 19, an external I/F (Interface) 20, a tuner 21, a descrambler 22, a demultiplexer (Demux) 23, a decoder 24, an output control section 25, and an output device 26.

The blocks included in the TV 2 are mutually connected via a bus, and data, for example, is exchanged among the blocks via the bus.

The control panel 11 is provided on the cabinet of the TV 2. The control panel 11 is operated by a user and supplies the operation signal corresponding to the operation to the CPU 12 via the bus.

The CPU 12 controls each of the blocks included in the TV 2 by loading and executing a program stored (recorded) in the EEPROM 13 or the HD 15 via the bus.

The EEPROM 13 stores a program, for example, to be executed by the CPU 12 and/or data, which is important to hold even after the TV 2 is powered off. The RAM 14 temporarily stores a program to be executed by the CPU 12 and/or data, which is important for an operation by the CPU 12. The HD 15 stores (records) a program to be executed by the CPU 12 and/or important data.

An application program (which will be called EPG application properly below) for displaying an EPG and performing other processing to be performed in relation to the EPG is installed in the EEPROM 13 or the HD 15. By executing the EPG application by the CPU 12, the TV 2 can function as the recording control apparatus in FIG. 3, which will be described later, that may control the display of an EPG, programming and the programmed recording by the recorder 4.

The clock unit 16 times and outputs the current time (or the data indicating it) onto the bus.

A removable recording medium 18 such as a flexible disk, a CD-ROM (Compact Disc Read Only Memory), an MO (Magneto Optical) disc, a DVD (Digital Versatile Disc), a magnetic disk and a semiconductor memory is removably installed to the drive 17. The drive 17 writes/reads data to/from the installed removable recording medium 18.

The receiving unit 19 receives an operation signal transmitted from the remote commander 3 and supplies it to the CPU 12 via the bus.

Here, the CPU 12 may control the display of an EPC or the selection of a channel with the tuner 21, for example, according to the operation signal supplied from the control panel 11 or the operation signal supplied from the remote commander 3 through the receiving unit 19.

The external I/F 20 functions as an I/F for performing the communication with external equipment such as the recorder 4 (in FIG. 1) and/or communication over a network such as the Internet or a LAN.

The tuner 21 receives the supply of a receive signal from the antenna 1. Under the control of the CPU 12 via the bus, the tuner 21 demodulates the receive signal of a desired channel from the receive signal from the antenna 1 and supplies the packet (TS packet) (or the sequence of packets) resulting from the demodulation to the descrambler 22.

Under the control of the CPU 12 via the bus, if the packet supplied from the tuner 21 is scrambled, the descrambler 22 descrambles the packet as necessary and supplies the descrambled packet to the demultiplexer (Demux) 23.

Under the control of the CPU 12 via the bus, the demultiplexer 23 extracts the packet containing PSI/SI from the packet (or the sequence) supplied from the descrambler 22 and supplies it to the CPU 12 via the bus.

The demultiplexer 23 extracts the packet containing video data and audio data as a program from the packet supplied from the descrambler 22 and supplies it to the decoder 24.

The decoder 24 has a video decoder 24V and an audio decoder 24A and, under the control of the CPU 12 via the bus, decodes the data contained in the packet from the demultiplexer 23 according to MPEG (Moving Picture Experts Group) method, for example, and supplies it to the output control section 25.

In other words, in the decoder 24, the video decoder 24V decodes video data contained in the packet from the demultiplexer 23 and supplies it to an output video control section 25V of the output control section 25. The audio decoder 24A decodes the audio data contained in the packet from the demultiplexer 23 and supplies it to an output audio control section 25A of the output control section 25.

The output control section 25 has the output video control section 25V and the output audio control section 25A and, under the control of the CPU 12 via the bus, controls the output of the video data and the audio data to the output device 26.

In other words, under the control of the CPU 12 via the bus, the output video control section 25V performs image processing on the video data from the video decoder 24V and supplies the result to a video display device 26V of the output device 26.

Under the control of the CPU 12 via the bus, the output audio control section 25A performs level adjustment, for example, on the audio data from the audio decoder 24A and supplies the result to an audio output device 26A of the output device 26.

The output device 26 has the video display device 26V and the audio output device 26A and displays images corresponding to the video data from the output control section 25 and outputs the sounds corresponding to the audio data from the output control section 25.

In other words, the video display device 26V may include a display such as an LCD (Liquid Crystal Display), an organic EL (Electro Luminescence) display and a plasma display and displays the images corresponding to the video data from the output video control section 25V.

The audio output device 26A may include a D/A (Digital/Analog) converter and a speaker and outputs the sounds corresponding to the audio data from the output audio control section 25A.

In the TV 2 in the configuration as described above, the CPU 12 upon powered on executes a program stored in the EEPROM 13 or the HD 15 and controls each of the blocks included in the TV 2.

Under the control of the CPU 12, the tuner 21 demodulates the receive signal of a desired channel from the receive signal from the antenna 1 and supplies the packet resulting from the demodulation to the descrambler 22. The descrambler 22 performs descrambling processing as necessary on the packet supplied from the tuner.21 and supplies the result to the demultiplexer 23.

The demultiplexer 23 extracts a necessary packet from the packets supplied from the descrambler 22 and supplies the packet containing PSI/SI, the packet containing video data and the packet containing audio data to the CPU 12, the video decoder 24V and the audio decoder 24A, respectively.

The video decoder 24V decodes the video data contained in the packet from the demultiplexer 23 and supplies the result to the output video control section 25V. The audio decoder 24A decodes the audio data contained in the packet from the demultiplexer 23 and supplies it to the output audio control section 25A.

The output video control section 25V processes the video data from the video decoder 24V and supplies it to the video display device 26V. Thus, the video display device 26V displays the images of the program.

The output audio control section 25A processes the audio data from the audio decoder 24A and supplies it to the audio output device 26A. Thus, the audio output device 26A outputs the sounds of the program.

Here, the program to be executed by the CPU 12 may be prestored in the EEPROM 13 or the HD 15, may be temporarily or permanently stored (or recorded) on the removable recording medium 18 or may be provided as package software to be installed to the TV 2.

Instead of the installation from the removable recording medium 18 to the TV 2 as described above, the program may be downloaded from a download site through the external I/F 20 and may be installed to the TV 2.

The processing steps herein of describing a program for causing the CPU 12, which is a computer, to perform a routine may not be performed in a time series manner in the order described on the flowchart, which will be described later, but may include processes (such as parallel processes or object-oriented processes) to be executed in parallel or separately.

The program may be processed by one CPU or by multiple CPUs in a distributed manner.

As described above, the EPG application, which is an application program for performing the display of an EPG and other processing to be performed in relation to the EPG, is installed in the EEPROM 13 or the HD 15. By executing the EPG application by the CPU 12, the TV 2 can function as a recording control apparatus that may control the display of an EPG, programming and programmed recording by the recorder 4.

FIG. 3 shows a configuration example of the recording control apparatus.

In FIG. 3, the recording control apparatus includes a program-related information storage section 51, an EPG data obtaining section 52, an EPG display control section 53, a programming section 54, a programming data storage section 55, a programmed recording control section 56, an estimated time storage section 57 and an estimated time setting section 58.

Here, the recording control apparatus performs processing according to an operation signal supplied from the control panel 11 (FIG. 2) or an operation signal transmitted from the remote commander 3 and received by the receiving unit 19. However, the control panel 11, the remote commander 3 and the receiving unit 19 will be properly collectively called operation unit 40 below.

The program-related information storage section 51 receives the supply of PSI/SI from the demultiplexer 23 (FIG. 2). The program-related information storage section 51 stores the PSI/SI from the demultiplexer 23. The PSI/SI stored in the program-related information storage section 51 can be referred as necessary by each of the blocks included in the recording control apparatus.

The EPG data obtaining section 52 loads and thus obtains EPG data for displaying the EPG from the PSI/SI stored in the program-related information storage section 51 and supplies it to the EPG display control section 53 and the programming section 54.

The EPG display control section 53 causes the video display device 26V to display an EPG based on the EPG data supplied from the EPG data obtaining section 52 according to the operation signal from the operation unit 40. The EPG display control section 53 displays an EPG with reference to the programming data stored in the programming data storage section 55 such that a user can recognize the programmed program (by displaying a mark, for example, indicating that the programming has been done in the program column of the programmed program, for example).

By operating the operation unit 40 by a user to program one of programs the program columns of which are displayed on an EPG as a target program, the EPG display control section 53 supplies the identification information for identifying the target program to the programming section 54.

The programming section 54 programs a program by creating programming data including the (broadcasting) channel, the recording starting time when the recording is to be started and the recording ending time when the recording is to be ended and supplying of the program to be programmed (target program) and storing the programming data to the programming data storage section 55 based on the operation signal supplied from the operation unit 40 in connection with the user's operation on the EPG displayed on the video display device 26v.

In other words, after a user operates the operation unit 40 to program a target program, the identification information for identifying the target program is, as described above, supplied from the EPG display control section 53 to the programming section 54.

The programming section 54 obtains the channel, broadcasting starting time and broadcasting ending time of the target program identified by the identification information from the EPG display control section 53 from the EPG data supplied from the EPG data obtaining section 52, defines the broadcasting starting time as the recording starting time and defines the broadcasting ending time as the recording ending time.

The programming section 54 creates the programming data including the channel of and recording starting time and recording ending time for the target program, creates a GUI (Graphical User Interface) of the configuration screen for confirming the programming based on the programming data and causes the video display apparatus 26V to display it.

Here, the confirmation screen displays the channel of and the recording starting time and recording ending time for the target program.

If the user viewing the confirmation screen operates the operation unit 40 to confirm the programming with the content displayed on the confirmation screen, the programming section 54 supplies and stores it to the programming data storage section 55. Thus, the programming is confirmed.

The programming section 54 does not perform the programming if the broadcasting starting time of the target program identified by the identification information from the EPG display control section 53 is not available from the EPG data supplied from the EPG data obtaining section 52.

The broadcasting starting time of the target program identified by the identification information from the EPG display control section 53 can be obtained from the EPG data supplied from the EPG data obtaining section 52. However, if the broadcasting ending time of the target program is not available, the programming section 54 loads the estimated time resulting form the estimation of the broadcasting time of the target program from the estimated time storage section 57 and defines, as the recording ending time, the time after the estimated time from the broadcasting starting time of the target program.

The programming data storage section 55 stores the programming data supplied from the programming section 54.

The programmed recording control section 56 controls the programmed recording of a program based on the programming data stored in the programming data storage section 55.

In other words, the programmed recording control section 56 refers to the current time output by the clock unit 16, and, when the current time reaches the recording starting time (or slightly before) included in the programming data stored in the programming data storage section 55, handles the programming data as focused programming data and transmits to the recorder 4 through the external I/F 20 a recording start command, which requests the start of recording of a program at the channel included in the focused programming data.

When the current time output by the clock unit 16 reaches the recording ending time included in the focused programming data, the programmed recording control section 56 further transmits a recording end command, which requests the end of recording, to the recorder 4 through the external I/F 20.

Here, the recorder 4 records (or is programmed to record) a target program according to the recording start command and recording end command from the programmed recording control section 56.

The estimated time storage section 57 stores an estimated time resulting from the estimation of the broadcasting time of a program of each genre in connection with the genre of the program, for example. In other words, the estimated time storage section 57 stores a genre and the estimated time, which is an estimated value of the broadcasting time of a program of the genre in connection with each other, such as 2 hours to the genre “Movie”, 1 hour to the genre “Variety” and 3 hours to the genre “Sports”.

The estimated time setting section 58 defines the estimated time for each genre, for example, based on a user's operation, that is, an operation signal supplied from the operation unit 40 and supplies and stores it to the estimated time storage section 57.

The estimated time setting section 58 can change (or update) the estimated time stored in the estimated time storage section 57 by rewriting the estimated time defined based on an operation signal from the operation unit 40 to the estimated time storage section 57.

The estimated time storage section 57 may store a predetermined estimated time prior to factory shipment.

In the recording control apparatus in the configuration as described above, PSI/SI is supplied from the demultiplexer 23 (FIG. 2) to the program-related information storage section 51, and the program-related information storage section 51 stores the PSI/SI from the demultiplexer 23.

Then, when a user operates the operation unit 40 to display an EPG, the recording control apparatus in FIG. 3 performs EPG display processing.

FIG. 4 is a flowchart illustrating the EPG display processing.

The EPG display processing in FIG. 4 ends when a user operates the operation unit 40 to end the EPG display.

In the EPG display processing, the EPG data obtaining section 52 in step S11 first loads and thus obtains EPG data from the PSI/SI stored in the program-related information storage section 51 and supplies it to the EPG display control section 53 and programming section 54. Then, the processing moves to step S12.

In step S12, the EPG display control section 53 causes the video display device 26V to display the EPG based on the EPG data from the EPG data obtaining section 52 according to the operation signal from the operation unit 40. Then, the processing moves to step S13.

In step S13, the EPG display control section 53 determines whether a user has performed the operation (or the programming operation) on the operation unit 40 to program one of programs the program columns of which are displayed on the EPG as a target program or not.

If it is determined in step S13 that the programming operation has not been performed, the processing returns to step S13, and the same processing is then repeated.

If it is determined in step S13 that the programming operation has been performed, the EPG display control section 53 supplies the identification information for identifying the target program to the programming section 54, and the processing moves to step S14 and subsequent steps where the processing of programming the target program is performed.

That is, in step S14, the programming section 54 determines the service type of the target program identified by the identification information from the EPG display control section 53 with reference to, for example, the PSI/SI stored in the program-related information storage section 51.

If it is determined in step S14 that the service type of the target program is not television broadcasting, that is, if the service type of the target program is radio broadcasting (or music broadcasting) or data broadcasting instead of television broadcasting, the program of such a service type is excluded from the target of the programming. Therefore, the processing moves to step S15, and the programming section 54 causes the video display device 26V to display an error message, and the processing returns to step S12.

If it is determined in step S14 that the service type of the target program is television broadcasting, the programming section 54 obtains the channel, broadcasting starting time and broadcasting ending time of the target program from the EPG data supplied from the EPG data obtaining section 52 (or the PSI/SIU stored in the program-related information storage section 51). Then, the processing moves to step S16.

In step S16, the programming section 54 determines whether the broadcasting starting time of the target program is available or not.

If it is determined in step S16 that the broadcasting starting time of the target program is not available, that is, the broadcasting starting time of the target program is information indicating that it is undetermined in the EPG data, for example, or that the EPG data does not have the broadcasting starting time of the target program, such a program is excluded from the target of the programming. Therefore, the processing moves to step S15 where the programming section 54 causes the video display device 26V to display an error message. Then, the processing returns to step S12.

If it is determined in step S16 that the broadcasting starting time of the target program is available, the processing moves to step S17 where the programming section 54 determines whether the broadcasting ending time of the target program is available or not.

If it is determined in step S17 that the broadcasting ending time of the target program is available, the processing moves to step S18 where the programming section 54 defines the broadcasting starting time as the recording starting time and defines the broadcasting ending time as the recording ending time. Then, the processing moves to step S20.

If it is determined in step S17 that the broadcasting ending time of the target program is not available, that is, the broadcasting ending time of the target program is information indicating that it is undetermined in the EPG data, for example, or that the EPG data does not have the broadcasting ending time, the processing moves to step S19 where the programming section 54 defines the broadcasting starting time as the recording starting time.

In step S19, the programming section 54 recognizes the genre of the target program based on the EPG data from the EPG data obtaining section 52, for example, and loads the estimated time in connection with the genre from the estimated time storage section 57. Then, the programming section 54 defines, as the recording ending time, the time after the estimated time loaded from the estimated time storage section 57 from the broadcasting starting time of the target program, and the processing moves from step S19 to step S20.

In step S20, the programming section 54 creates the programming data including the channel, the recording starting time and recording ending time for the target program and creates the confirmation screen for confirming that the programming is performed based on the programming data and causes the video display device 26V to display it.

After that, the processing moves from step S20 to step S21, and the programming section 54 determines whether the operation unit 40 has been operated to confirm the programming (for the confirming operation) or not.

If it is determined in step S21 that no confirming operation has been performed, the processing moves to step S22 where the programming section 54 determines whether the operation unit 40 has been operated to cancel the programming (for the canceling operation) or not.

If it is determined in step S22 that the canceling operation has been performed, the programming section 54 closes the confirmation screen displayed in step S20, and the processing returns to step S12. Subsequently, the same processing is repeated.

If it is determined in step S22 that no canceling operation has been performed, the processing returns to step S21.

Then, if it is determined in step S21 that the confirmation operation has been performed, that is, if a user viewing the confirmation screen performs the confirmation operation on the operation unit 40 to confirm the programming with the content displayed on the confirmation screen, the processing moves to step S23 where the programming section 54 supplies and stores the programming data to the programming data storage section 55. After that, the processing returns to step S12, and the same processing is performed subsequently.

If the programming data has been already stored in the programming data storage section 55, the programmed recording control section 56 refers to the current time output by the clock unit 16, handles the programming data including the recording starting time equal to the current time as focused programming data and transmits to the recorder 4 through the external I/F 20 the recording start command, which requests the start of recording of the program at the channel included in the focused programming data.

When the current time output by the clock unit 16 reaches the recording ending time included in the focused programming data, the programmed recording control section 56 transmits the recording end command, which requests the end of recording, to the recorder 4 through the external I/F 20 and deletes the focused programming data from the programming data storage section 55.

In the recorder 4, the target program is recorded (or programmed to record) according to the recording start command and recording end command from the programmed recording control section 56.

As described above, if the broadcasting ending time of a target program is not available, the programming section 54 defines, as the recording ending time, the time after the estimated time stored in the estimated time storage section 57 from the broadcasting starting time of the target program. Therefore, a user can use an EPG to program even a program the broadcasting ending time of which is not available, without taking time unlike the programming by specifying the date and time of a target program.

A reasonable time can be defined as the recording ending time since the recording ending time is defined by using the time defined for each genre of programs or the time defined based on a user's operation as the estimated time.

Having described that the estimated time setting section 58 defines the estimated time based on a user's operation according to this embodiment, the estimated time may be defined based on a user's preference, for example, instead.

In other words, the estimated time setting section 58 may define the broadcasting time of a program which is viewed by the user relatively frequently as the estimated time for the genre of the program. For example, in a case where the TV 2 has a function of recording a program under the title including a keyword registered by a user, as in so-called “Intelligent Recording”, the broadcasting time of the program recorded by Intelligent Recording may be defined as the estimated time for the genre of the program.

Here, the estimated time setting section 58 may further store the genre of programs viewed by a user relatively frequently or the genre of programs recorded by Intelligent Recording as the genre based on the user's preference. Then, the programming section 54 may guess the genre of a target program as the genre based on the user's preference and define the recording end time by using the estimated time in connection with the genre.

The estimated time setting section 58 may define the estimated time for each genre of programs based on the genre of programs the broadcasting starting times and broadcasting ending times of which are available, the broadcasting starting times and broadcasting ending times.

In other words, the estimated time setting section 58 may obtain the broadcasting time of a program the broadcasting starting time and the broadcasting ending time of which are available from the broadcasting starting time and the broadcasting ending time and define the average value or the maximum value of the multiple broadcasting times obtained from programs of a certain genre as the estimated time for the genre.

The estimated time setting section 58 can change the estimated time stored in the estimated time storage section 57 based on a user's operation.

In other words, for example, the TV 2 may display a message that inquires a user of whether the recording ending time is right or not in the programming data including the recording ending time defined by using the estimated time. If a user operates the operation unit 40 to the message to point out that the recording ending time is too early or too late, the estimated time stored in the estimated time storage section 57 can be changed to a longer or shorter time than the current estimated time according to the operation.

The estimated time setting section 58 may further change the estimated time stored in the estimated time storage section 57 based on the playback time of the programmed program.

In other words, the estimated time setting section 58 may recognize the playback time of the program when the programmed program is played and change the stored content in the estimated time storage section 57 by handing the playback time as the estimated time of the genre of the played program.

Having described that the estimated time for each genre is stored in the estimated time storage section 57 according to this embodiment, one long estimated time such as 24 hours may be stored in the estimated time storage section 57, irrespective of the genre.

In this case, after the recorder 4 starts the programmed recording of a target program, the programmed recording control section 56 (FIG. 3) may refer the PSI/SI supplied from the demultiplexer 23 to the program-related information storage section 51 and detect whether the next program of the target program has been started or not. If it is detected that the broadcasting of the next program of the target program has been started before the recording ending time of the target program, the programmed recording control section 56 may end the programmed recording of the target program by transmitting the recording end command to the recorder 4 through the external I/F 20.

Having described the programmed recording by the recorder 4 is controlled by transmitting the recording start command and recording end command from the programmed recording control section 56 to the recorder 4 according to this embodiment, programming data may be transmitted from the programmed recording control section 56 to the recorder 4, and the recorder 4 may perform the programmed recording according to the programming data.

Having described that a program broadcasted by digital broadcasting is a target of the programming according to this embodiment, the program subject to the programming is not limited to the program broadcasted by digital broadcasting. Alternatively, a distributed program such as a program transmitted over a network such as the Internet may be the target of the programming.

If the distribution ending time of a target program is available where the times when the distribution of a program to be distributed including a program to be broadcasted by digital broadcasting starts and ends are the distribution starting time and the distribution ending time, the programmed recording control section 56 defines the distribution ending time as the recording ending time. If the distribution ending time of the target program is not available, the time after an estimated time from the distribution starting time of the target program is defined as the recording ending time.

Having described above the case where the invention is applied to a TV that controls the programmed recording by an HD recorder, for example, the invention is also applicable to an HD recorder that performs programmed recording.

For example, the invention is also applicable to a client machine in a system in which the client machine on a network (such as a cellular phone connectable to the Internet) programs a server machine (such as a home HD recorder connecting to the Internet) by obtaining and using an EPG.

The embodiments of the invention are not limited to the embodiments as described above, but various changes may be made thereto without departing from the spirit and scope of the invention.

What is claimed is:

1. A control apparatus that controls the programmed recording of a program, the apparatus comprising:
an EPG (Electronic Program Guide) data obtaining section obtaining EPG data for displaying an EPG;
an EPG display control section causing a display device, which displays an image, to display an EPG based on the EPG data; and
a programming section programming a program by creating programming data including a recording ending time when the recording of a program is to be ended based on a user's operation on the EPG,
wherein the programming section
defines a distribution ending time when the distribution of a target program, which is a program to be programmed, is to be ended as the recording ending time if the distribution ending time is available; or
defines, as the recording ending time, the time after a predetermined estimated time stored in a storage section, which stores information, from a distribution starting time when the distribution of the target program is to be started if the distribution ending time of the target program is not available.

2. The control apparatus according to claim 1, wherein the storage section stores the programmed time in connection with the genre of programs; and
the programming section defines, as the recording ending time, the time after the estimated time in connection with the genre of the target program from the distribution starting time of the target program.

3. The control apparatus according to claim 1, further comprising:
an estimated time setting section setting the estimated time to be stored in the storage section.

4. The control apparatus according to claim 3, wherein the estimated time setting section defines the estimated time based on a user's operation.

5. The control apparatus according to claim 3, wherein the estimated time setting section defines the estimated time based on a user's preference.

6. The control apparatus according to claim 3, wherein the estimated time setting section defines the estimated time for each genre of programs in connection with the genre based on the genre of a program the distribution starting time and distribution ending time of which are available, the distribution starting time and the distribution ending time; and
the programming section defines, as the recording ending time, the time after the estimated in connection with the genre of the target program from the distribution starting time of the target program.

7. The control apparatus according to claim 3, wherein the estimated time setting section further changes the estimated time stored in the storage section based on a user's operation.

8. The control apparatus according to claim 3, wherein the estimated time setting section further changes the estimated time stored in the storage section based on the playback time of the programmed program.

9. The control apparatus according to claim 1, further comprising:
a programmed recording control section controlling the programmed recording of a program based on the programming data,
wherein the programmed recording control section ends the programmed recording of the target program if the distribution of the next program of the target program is started after the programmed recording of the target program is started and before the recording ending time of the target program is started.

10. A control method that controls the programmed recording of a program, the method comprising the steps of:
obtaining EPG (Electronic Program Guide) data for displaying an EPG;
controlling a display device, which displays an image, to display an EPG based on the EPG data; and
programming a program by creating programming data including a recording ending time when the recording of a program is to be ended based on a user's operation on the EPG,
wherein the programming step
defines a distribution ending time when the distribution of a target program, which is a program to be programmed, is to be ended as the recording ending time if the distribution ending time is available; or
defines, as the recording ending time, the time after a predetermined estimated time stored in a storage section, which stores information, from a distribution starting time when the distribution of the target program is to be started if the distribution ending time of the target program is not available.

11. A program causing a computer to function as a control apparatus that controls the programmed recording of a program, the apparatus comprising:
an EPG data obtaining section obtaining EPG data for displaying an EPG (Electronic Program Guide);
an EPG display control section causing a display device, which displays an image, to display an EPG based on the EPG data; and
a programming section programming a program by creating programming data including a recording ending time when the recording of a program is to be ended based on a user's operation on the EPG,
wherein the programming section
defines a distribution ending time when the distribution of a target program, which is a program to be programmed, is to be ended as the recording ending time if the distribution ending time is available; or
defines, as the recording ending time, the time after a predetermined estimated time stored in a storage section, which stores information, from a distribution starting time when the distribution of the target program is to be started if the distribution ending time of the target program is not available.
